(19) United States
(12) Patent Application Publication
(10) Pub. No.: US 2014/0067454 A1
(43) Pub. Date: Mar. 6, 2014

(54) Reconciling Multiple Proposed Event Times Among Event Participants

(71) Applicants: Devrim Varoglu, Santa Clara, CA (US); Swapnil Dave, Santa Clara, CA (US)

(72) Inventors: Devrim Varoglu, Santa Clara, CA (US); Swapnil Dave, Santa Clara, CA (US)

(73) Assignee: Apple Inc., Cupertino, CA (US)

(21) Appl. No.: 13/597,894

(22) Filed: Aug. 29, 2012

(51) Int. Cl. G06Q 10/06

(52) U.S. Cl. 705/7.18

(57) ABSTRACT

A scheduling application on a first device may be configured to identify multiple time periods that comply with a set of scheduling parameters for a proposed event. An invitation to the proposed event that includes the multiple time periods may then be sent to one or more second devices, where after users corresponding to the second devices may accept the invitation by selecting one or more of the multiple time periods. The selected one or more time periods from each of the second user devices may be sent to the first device and the event may be scheduled on each of the first and second devices according to a selected time.

### BACKGROUND

This disclosure relates generally to event scheduling using electronic devices. More particularly, but not by way of limitation, it relates to techniques to improve the flexibility in electronically scheduling an event between two or more parties using a scheduling application.

Many users employ applications on electronic devices such as mobile phones, personal music players, tablet computers, personal computers, and other similar devices to schedule theft day-to-day activities. For example, a user may document a scheduled event for a personal or professional activity using a scheduling application on a device. The documented event may identify a subject of the event (e.g., teleconference, dinner, meeting, etc.), other event attendees, a time frame for the event, and other relevant information related to the event. By documenting scheduled events, the user ray be able to view all of the scheduled events during a particular time period, may receive reminders as a scheduled event approaches, and may avoid scheduling multiple events at the same time. Thus, scheduling applications on electronic devices have replaced paper-based schedules for many users.

In addition to allowing a user to document scheduled events, scheduling applications may allow a user to create and respond to event invitations. For example, a user may receive an invitation to an event that identifies other invitees, the subject of the event, and a time period in which the event is to occur. Upon accepting the invitation, the event may be documented in the scheduling application at the specified event tune in the same manner as if the event was manually created. However, if the user has a conflicting event at the time specified in the invitation, the user may not be able to accept the invitation. As such, the user may propose an alternate time or may simply reject the invitation. Neither of these actions is optimal as they result in either decreased attendance or a time consuming back-and-forth interaction to settle on a suitable event time. The situation is further complicated as the number of invitees increases. It would therefore be desirable to improve the flexibility in electronically scheduling an event between two or more parties using a scheduling application.

### SUMMARY

In one embodiment, a method to generate an event invitation that includes multiple proposed event time periods is disclosed. An invitation for an event specifying multiple proposed event time periods may be sent from a first device to a second device and an acceptance of the invitation that specifies an accepted time period that corresponds to one of the multiple proposed event tune periods may be received. A notification for the proposed event corresponding to the accepted event time period may be set on the first device. Additionally, the proposed event and the accepted event time period may be stored in a memory on the first device. The method may be embodied in program code and stored on a non-transitory storage medium. The stored program code may be executed by a processor that is part of, or controls, the first device.

In another embodiment, a method to generate an event invitation that includes multiple proposed event times is disclosed. A first device receives scheduling parameters for a proposed event. Multiple time periods during which a user of the first device is available and that correspond to the scheduling parameters may be identified and a selection of more than one proposed event time periods from the identified time periods may be received. An invitation for the proposed event that includes the more than one proposed event time periods may be sent to a second device and a response specifying one or more accepted event time periods from the proposed event time periods may be received. The method may be embodied in program code and stored on a non-transitory storage medium. The stored program code may be executed by a processor that is part of, or controls, the first device.

In another embodiment, a method to receive and respond to an event invitation that includes multiple proposed event times is disclosed. An event invitation that identifies multiple proposed event times may be received by a second device from a first device. One or more of the proposed event times that conflict with existing events may be identified. The proposed event times that do not conflict with the existing events may be presented to a user of the second device and a selection of one of the presented times may be sent to the first device. The method may be embodied in program code and stored on a non-transitory storage medium. The stored program code may be executed by a processor that is part of, or controls, the second device.

In still another embodiment, a method to determine an availability of multiple proposed event invitees is disclosed. Scheduling parameters that identify a duration, a time frame, and multiple proposed event invitees for a proposed event may be received at a first device. The scheduling parameters may then be sent to the multiple invitees and responses that identify available times of the invitees during the proposed event time frame may be received. An overlapping time period may be identified from the responses and an invitation for the proposed event that specifies the overlapping time period as a proposed event time period may be sent to the invitees. The method may be embodied in program code and stored on a non-transitory storage medium. The stored program code may be executed by a processor that is part of, or controls, the first device.

### BRIEF DESCRIPTION OF THE DRAWINGS

FIG. 1 is a flowchart that illustrates an operation to provide multiple scheduling options for a proposed event to event invitees in accordance with one embodiment.

FIG. 2 is a block diagram that illustrates the schedules of an event initiator and an event invitee in accordance with an event invitation that includes multiple scheduling options in accordance with one embodiment.

FIG. 3 is a flowchart that illustrates an operation to identify the availability of proposed event invitees in accordance with one embodiment.

FIG. 4 is a block diagram that illustrates the comparison of multiple invitees' schedules with received scheduling parameters in accordance with one embodiment.

FIG. 5 is a block diagram of an illustrative electronic device in accordance with one embodiment.

### DETAILED DESCRIPTION

This disclosure pertains to systems, methods, and computer readable media for scheduling an event. In general, techniques are disclosed for determining the availability of proposed event attendees and sending multiple proposed event times to the attendees.

In the following description, for purposes of explanation, numerous specific details are set forth in order to provide a thorough understanding of the inventive concept. As part of this description, some of this disclosure's drawings represent structures and devices in block diagram form in order to avoid obscuring the invention. In the interest of clarity, not all features of an actual implementation are described in this specification. Moreover, the language used in this disclosure has been principally selected for readability and instructional purposes, and may not have been selected to delineate or circumscribe the inventive subject matter, resort to the claims being necessary to determine such inventive subject matter. Reference in this disclosure to “one embodiment” or to “an embodiment” means that a particular feature, structure, or characteristic described in connection with the embodiment is included in at least one embodiment of the invention, and multiple references to “one embodiment” or “an embodiment” should not be understood as necessarily all referring to the same embodiment.

It will be appreciated that in the development of any actual implementation (as in any development project), numerous decisions must be made to achieve the developers' specific goals (e.g., compliance with system- and business-related constraints), and that these goals will vary from one implementation to another. It will also be appreciated that such development efforts might be complex and time-consuming, but would nevertheless be a routine undertaking for those of ordinary skill in the art having the benefit of this disclosure.

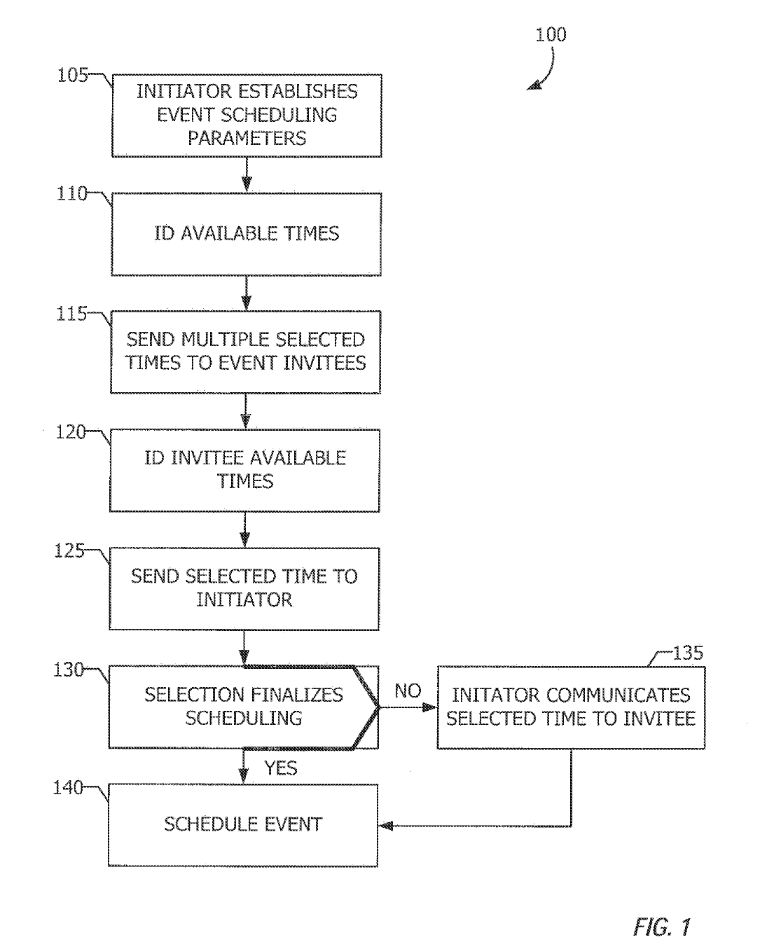

Referring to FIG. 1, scheduling operation 100 enables an event initiator to present multiple scheduling options for a proposed event to event invitees. The event may include a telephone call, a meeting, a presentation, a conference, or any other type of scheduled activity. Scheduling operation 100 may be initiated when an event initiator establishes scheduling parameters for the event (block 105). Scheduling parameters may be entered using a scheduling application on the initiator's device. In one embodiment, scheduling parameters may specify desired timing properties for the event such as an estimated event duration and a time frame in which the initiator would like the event to occur (e.g., a block of consecutive days, a particular day, a block of time on a particular day, etc.). For example, the initiator may desire to schedule a thirty minute meeting between 8:00 AM and 12:00 PM on a particular day.

The scheduling parameters may be reconciled with any of the initiator's existing scheduled events to identify multiple available times for the proposed event that comply with the scheduling parameters (block 110). In one embodiment, the scheduling parameters may be reconciled with existing events in the scheduling application that received the scheduling parameters. For example, the scheduling application may maintain a record of scheduled events and may compare the scheduling parameters to the scheduled events. In another embodiment, the scheduling parameters may be reconciled with existing events in both the scheduling application and other applications on the event initiator's device (e.g., a reminders application, a social network application, etc.). The scheduling application may return all available times (i.e., times for which no conflict exists) for the proposed event that comply with the scheduling parameters. Continuing the example from above in which scheduling parameters indicate an event duration of thirty minutes between 8:00 AM and 12:00 PM, if the scheduling application identifies existing initiator events from 8:00 AM-8:30 AM, 9:30 AM-10:00 AM, and 11:00 AM-11:30 AM, the scheduling application may identify available event times from 8:30 AM-9:30 AM, 10:00 AM-11:00 AM, and 11:30 AM-12:00 PM.

The identified available times may be presented to the event initiator for selection of multiple available times that are acceptable. Again continuing the above example, the initiator may determine that the 11:30 AM-12:00 PM available time is not acceptable (e.g., is undesirable or is in conflict with an existing appointment that could not be identified by the scheduling application) but may select the 8:30 AM to 9:30 AM and 10:00 AM-11:00 AM time slots.

An invitation to participate in the proposed event that includes the multiple selected time slots may then be transmitted to one or more event invitees (block 115). The event invitation may identify proposed attendees, a subject of the event, an event agenda, etc. Of particular relevance to operation 100, however, is the provision of multiple proposed event times rather than the specification of a single event time.

In one embodiment, the event invitation may be sent to proposed invitees indirectly. For example, the scheduling application on the initiator device may generate a message (e.g., an email, social network, or instant messaging message) that is communicated to a server device (e.g., a web server) via a network connection and is retrieved by an invitee's device from the server device via the same or different network connection. In such an embodiment, the network connection may take any form including, but not limited to, a local area network (LAN), a wide area network (WAN) such as the Internet or a combination of local and wide-area networks. Moreover, the network may use any desired technology, or combination of technologies (wired, wireless or a combination thereof) and protocol (e.g., transmission control protocol, TCP). In another embodiment, the event invitation may be sent directly to one or more event invitees. For example, the message may be communicated via a network connection between the initiator's device and the device of one or more event invitees, such as via a short message service (SMS) text message. In such an embodiment, the initiator may provide device identifiers (e.g., mobile device telephone numbers) for the event invitees.

In one embodiment, for proposed event time slots of a greater duration than that of the proposed event, the scheduling application may segregate the time slot into multiple proposed event times having the proposed event duration. For example, for the 8:30 AM-9:30 AM time slot, the scheduling application may send event invitations having proposed event times of 8:30 AM-9:00 AM-8:40 AM-9:10 AM, 8:50 AM-9:20 AM, and 9:00 AM-9:30 AM. In an alternate embodiment, the event invitation may simply identify the available time slots and may allow a recipient to select any event time period having the proposed event duration within the available time slots.

Upon receipt, the event invitation may be processed by the same or a different scheduling application on the invitee's device. The scheduling application on the invitee device may identify available times that correspond to the multiple proposed event time slots (block 120). Stated differently, the scheduling application on the invitee device may identify an intersection of the invitee's available times (i.e., times for which no prior event has been scheduled) with the multiple proposed event time slots. The identification of the invitee's available times may be performed in a similar manner to the identification of the initiator's available times (as described with respect to block 110). That is, the scheduling application on the invitee's device may identify existing scheduled events within the scheduling application and may request information regarding existing scheduled events from other applications. Once the invitee's available times have been identified, the invitee may select one or more available times and the selected times may be sent to the initiator using the same or a different communication channel from that used to receive the invitation (block 125). It may then be determined if the selected time finalizes the scheduling process (block 130). The scheduling process may be finalized if a sole event invitee selects a single time that corresponds to the duration of the proposed event. If the invitee's selection results in the finalization of the scheduling process (the “Yes” prong of block 130), the event may be scheduled (e.g., added to the scheduling applications on the initiator's and invitee's devices) (block 140). It should be noted that the determination of whether an invitee selection finalizes the scheduling process may be made on both the initiator's device and the invitee's device such that no additional communication between the devices is necessary. On both the initiator's device and the invitee's device, the event may be scheduled by saving data that describes the event and the selected time in a memory on the device. In conjunction with the scheduling of the event, the scheduling application may set up a user notification corresponding to the selected event time. In one embodiment, the user notification may provide an alert (e.g., a display, a generated audio tone, etc.) to the user at the selected event time (or some time prior to the selected event time).

It may, however, be determined that the invitee's selection does not result in the finalization of the scheduling process (the “No” prong of block 130). For example, if there are multiple event invitees, a single invitee's selection of a proposed event time may not result in the finalization of scheduling (e.g., because the selected time may not correspond to an available time of other invitees). Similarly, if an invitee (either a sole invitee or one of multiple invitees) selects multiple event times, event scheduling may not be finalized (e.g., because further selection of the final time is still required). In either case, control of the event scheduling process may be transferred to the initiator.

If a sole invitee selects multiple event times, the initiator may choose from the selected times to finalize the scheduling process. If multiple invitees have selected one or more overlapping event times (i.e., the invitees have each selected at least one common event time), the initiator may finalize the scheduling process by selecting one of the one or more overlapping event times. If multiple invitees have not selected at least one overlapping event time, the event may either be cancelled by the initiator or may be scheduled with less than all of the invitees (e.g., when the initiator selects an event time that was selected by less than all of the invitees). The initiator's selection may result in the scheduling of the event in the scheduling application on the initiator's device and may be communicated to the invitees' devices (block 135) such that the selection may be effected in the scheduling applications of the invitees' devices (block 140) (e.g., by saving data representing the event in a memory on the initiator's device and the invitees' devices). It will be noted that the initiator's selection may be effected differently on different individual invitees' devices based on the initiator's selection. For example, the initiator's selection may be effected by scheduling the event in a scheduling application on an invitee's device, by removing the invitee's proposed time from the scheduling application (e.g., if the invitee will be omitted from the meeting based on the initiator's selection), etc. According to scheduling operation 100, an event initiator can provide scheduling flexibility by allowing event invitees to select from multiple proposed event times rather than simply specifying an event time.

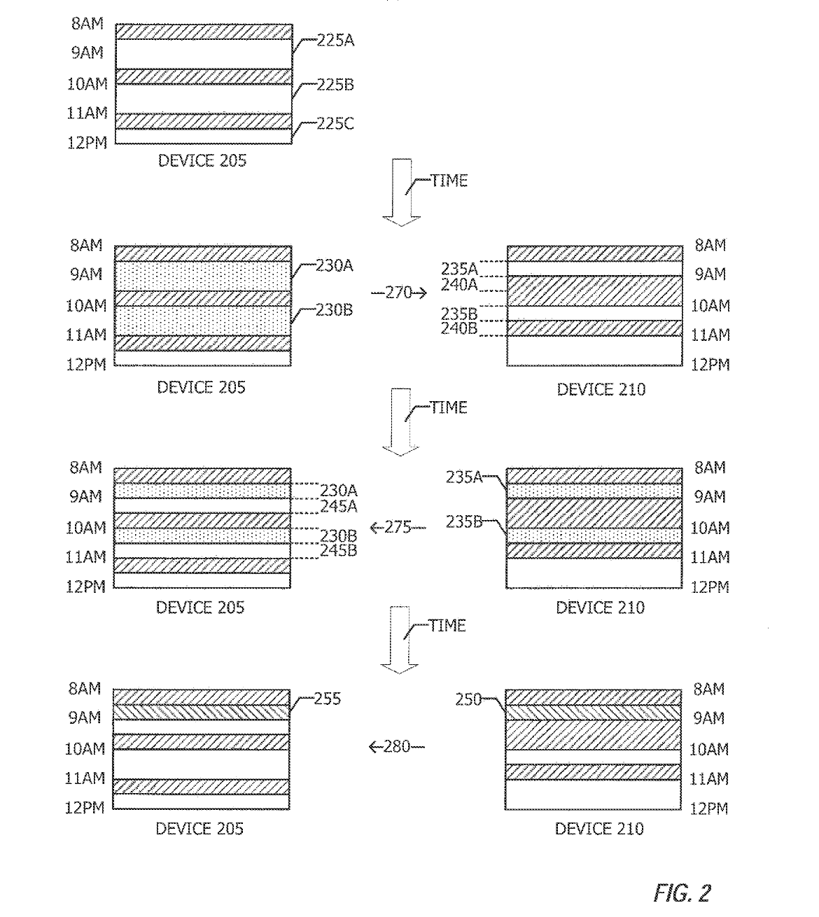

Referring to FIG. 2, an event initiator's schedule is maintained in a scheduling application on device 205. The event initiator may identify a block of time between 8:00 AM and 12:00 PM in which the initiator would like to schedule a thirty minute event. In accordance with scheduling operation 100, the event scheduling parameters may be provided to the scheduling application and the scheduling application may identify multiple available times 225 during which the initiator does not have an existing event scheduled. Of available times 225, the event initiator may select times 225A and 225B as proposed event times to be communicated in an event invitation. The scheduling application may then create blocked entries 230A and 2308 for the selected proposed event times and may transmit an event invitation with the multiple proposed event times to an invitee (as illustrated by arrow 270). The creation of blocked event times 230A and 230B may ensure that no events are scheduled for the event initiator during the proposed event time while the proposed event is pending.

The event invitation may subsequently be received at device 210 and may be processed by a scheduling application on device 210. Initially, the scheduling application on device 210 may identify any available times during which the event could be conducted. Of the proposed event times, the scheduling application on device 210 may identify available times 235A and 235B that do not conflict with existing scheduled events and during which an event of the specified duration could be conducted. The scheduling application on device 210 might also identify conflicting times 240A and 240B during the proposed event times for which the invitee has existing scheduled events.

In the illustrated embodiment, the scheduling application on device 210 may generate a reply to the event invitation to communicate available times 235A and 235B (or alternatively conflicting times 240A and 240B) to the initiator (as illustrated by arrow 275). It should be noted that the identification of available times 235A and 235B and conflicting times 240A and 240B (and the communication of these times) may occur without any action on the part of a user of device 210. It will be understood that to allow an invitee device to automatically communicate available times to an initiator device, a user of the invitee device may be required to enable such functionality from within the scheduling application. Upon receipt of available times 235A and 235B (or conflicting times 240A and 240B), the scheduling application on device 205 may after blocked event times 230A and 230B according to the invitee's available times such that the initiator can schedule additional events within available times 245A and 245B. In one embodiment, available times 235A and 235B may be blocked on device 210 such that no events are scheduled during the available times prior to the user of device 210 accepting or rejecting the event invitation.

Upon viewing the available event times 235A and 235B, the user of device 210 may select to accept the event invitation during available time 235A. Because the user of device 210 is the sole invitee and has selected a single proposed event time that corresponds to the duration of the proposed event, the scheduling application may schedule the event from 8:30 AM to 9:00 AM (accepted event time 250). Moreover, the scheduling application on device 210 may generate a reply accepting the event invitation and communicating accepted event time 250 to the event initiator (as illustrated by arrow 280). Upon receipt of the reply, the scheduling application on device 205 may schedule the event by creating scheduled event time 255 and removing blocked event time 230B.

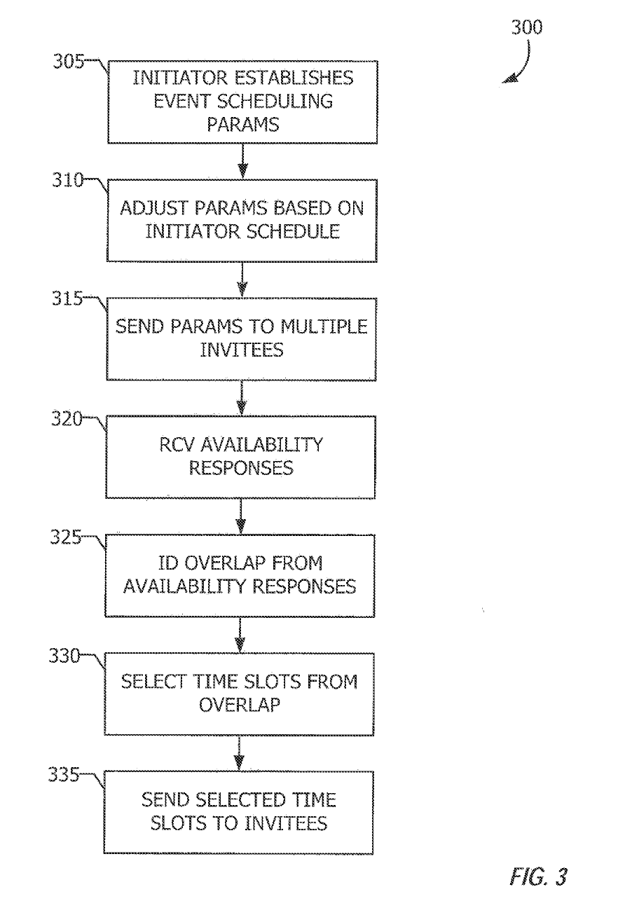

Referring to FIG. 3, participant availability operation 300 may identify multiple event times during which all (or a substantial portion of) event invitees are available. As will be described in greater detail below, operation 300 may eliminate the back-and-forth process of honing in on a meeting time that is suitable for a large number of event invitees. Operation 300 may begin with the establishment of event scheduling parameters by an event initiator (block 305). As described above with respect to scheduling operation 100, event scheduling parameters may be entered using a scheduling application on the initiator's device and may specify desired timing properties for the event such as an estimated duration of the event and a time frame in which the initiator would like the event to occur. Also similar to operation 100, the scheduling application on the initiator's device may identify the initiator's own available times that correspond to the received event scheduling parameters (block 310). Accordingly, the scheduling parameters entered by the initiator may be adjusted to account for the initiator's existing scheduled events.

The scheduling parameters may then be sent to multiple event invitees (block 315). The transmission of the scheduling parameters to the multiple invitees may occur in a similar manner to the transmission of an event invitation described in operation 100. However, unlike an event invitation, the scheduling parameters may not be capable of being accepted by an invitee. Rather, the scheduling parameters may be utilized to collect information regarding invitee availability. In one embodiment, the modified scheduling parameters may be sent to each of the multiple invitees simultaneously. In another embodiment, the scheduling parameters may specify an event invitee ranking and the scheduling parameters may be sent to the invitees in order of their ranking. In such an embodiment, event invitees whose attendance at the event is more critical than other event invitees may receive the scheduling parameters first such that the scheduling parameters may be matched to the schedules of the more critical invitees first. In one embodiment, the scheduling parameters may be sent to each invitee in a first subset of invitees according to a ranking and may be subsequently transmitted to each of the invitees in a second subset simultaneously.

An availability response may be received by the scheduling application on the initiator's device from each of the event invitees (block 320). An availability response from a particular invitee may indicate all of the times corresponding to the received scheduling parameters during which the invitee is available (e.g., does not have a conflicting event). In one embodiment, the availability response may be received in the form of modified scheduling parameters. That is, the availability response may remove time periods during which an invitee has a conflicting event from the received scheduling parameters. If the scheduling parameters are sent to invitees according to a predefined ranking, the modified scheduling parameters may be sent back to the initiator. In another embodiment, the modified scheduling parameters may be sent from one invitee to the next invitee in the ranking. In either case, the scheduling parameters may be modified based on a conflicting event of a particular invitee such that the conflicting time slot is not presented to another invitee.

In one embodiment, the availability response from each invitee may be received without interaction on the part of the invitee. For example, a scheduling application on the invitee's device that received the scheduling parameters may identify any conflicting events during the times specified in the received scheduling parameters and may generate a response that includes the invitee's available times (e.g., may modify the scheduling parameters based on conflicting events). The identification of available times on each invitee device may be similar to the identification of available times on the initiator's device (i.e., at block 310). In another embodiment, the invitee may manually adjust the availability response. For example, an invitee may wish to exclude a time period during which they have an appointment that has not been entered in their scheduling application. In such an embodiment, the invitee may be required to make any adjustments to the identified available times within a certain time period from receiving the scheduling parameters. If no input is received from the invitee during the specified time period, the scheduling application on the invitee's device may generate an availability response that includes the automatically identified available times. In one embodiment, the initiator may specify in the scheduling parameters whether one or more invitees should be allowed to manually adjust the availability response and the time period for making such adjustments.

After receiving the availability responses from each of the invitees (or after a specified time-out period), the scheduling application on the initiator's device may identify overlapping times in the availability responses (block 325). If the scheduling parameters were sent to multiple invitees simultaneously, the scheduling application on the initiator's device may identify time periods from the received availability responses in which each of the invitees is available. If no time periods exist when all of the invitees are available, the scheduling application may identify time periods during which the largest number of invitees are available. In one embodiment, an initiator may mark certain invitees as “necessary” invitees. In such an embodiment, if no time periods exist during which all of the invitees are available, the scheduling application may identify time periods during which the “necessary” invitees are available. If the scheduling parameters were sent to invitees according to a specified order (with the scheduling parameters modified based on each individual invitee's availability response), the scheduling application on the initiator's device may identify all of the time periods in the availability response received from the last invitee as the overlapping times. The identified overlapping times may represent the times during which the greatest number of event participants may be able to participate in the event. The initiator may select one or ore times from the overlapping times (block 330), where after the selected times may be sent to the invitees in the form of an event invitation (block 335). The event may subsequently be scheduled as described in operation 100.

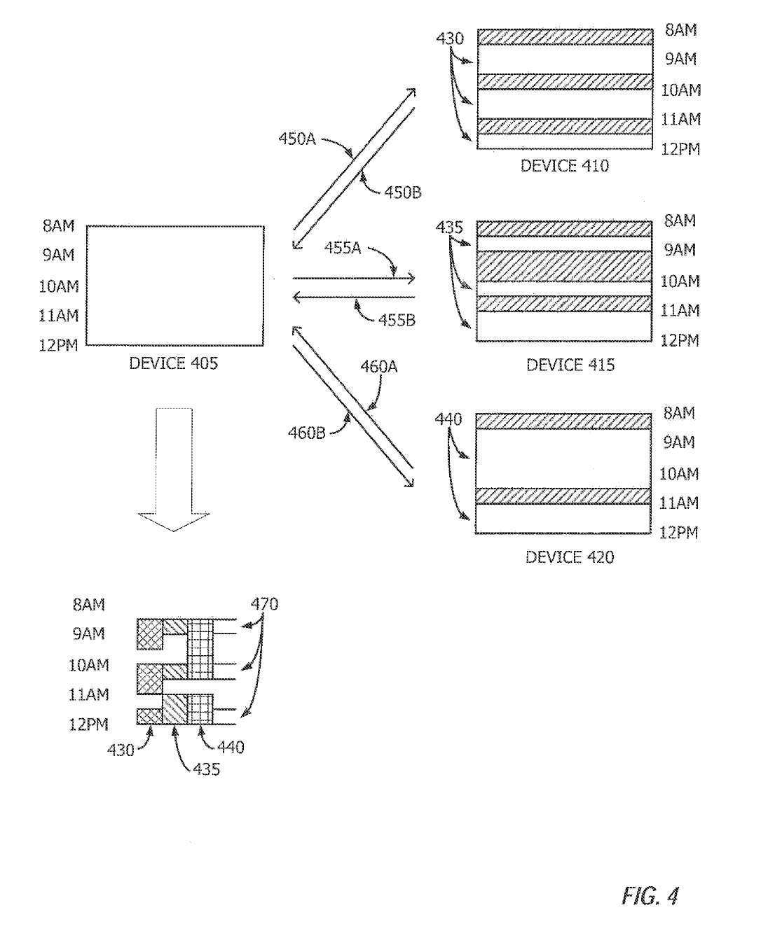

Referring to FIG. 4, an event initiator may wish to schedule an event that includes multiple invitees. In order to propose an event time that will allow the largest number of invitees to participate, the initiator may determine that a participant availability operation should be performed prior to sending an event invitation, in accordance with the participant availability operation, the initiator may specify an event duration and a proposed time frame for the event. In the illustrated embodiment, the initiator may enter scheduling parameters that specify a thirty minute duration for an event to occur between 8:00 AM and 12:00 PM on a specific day in a scheduling application on initiator device 405. The scheduling parameters may also identify multiple invitees. The scheduling parameters may then be sent (as indicated by arrows 450A, 455A, and 460A) to each of the invitees (either according to a specified order or simultaneously) and may be received by a scheduling application on each invitee's device (e.g., devices 410, 415, and 420). Upon receipt of the scheduling parameters, the scheduling application on each invitee device may identify time periods that comply with the scheduling parameters during which the invitee is available (i.e., during which no existing events are scheduled). For example, the scheduling application on device 410 may identify availability time slots 430 during which the user of device 410 is available, the scheduling application on device 415 may identify availability time slots 435 during which the user of device 415 is available, and the scheduling application on device 420 may identify availability time slots 440 during which the user of device 420 is available. In one embodiment, the availability time slots may be identified and transmitted back to initiator device 405 without any action on the part of an invitee. In another embodiment, the user may adjust the automatically identified availability time slots before an availability response is generated by the device. In such an embodiment, the scheduling parameters may specify a time by which availability responses should be received by initiator device 405 and the scheduling application on the invitee device may hold an availability response until the specified time to allow the invitee to make any adjustments to the automatically identified times and may send the availability response that includes the automatically identified times if no adjustments are made prior to the specified time.

Availability responses that include availability times 430, 435, and 440 may then be sent by devices 410, 415, and 420 (as indicated by arrows 450B, 455B, and 460B). In one embodiment, upon sending an availability response, the scheduling application on an invitee device may block the availability times identified in the availability response such that a subsequent event is not scheduled during an identified available time. In such an embodiment, an invitee may be capable of scheduling a subsequent event during a blocked time by sending an updated availability response prior to the receipt of an event invitation related to the previously-received scheduling parameters. In another embodiment if scheduling parameters for an event having a higher priority than the scheduling parameters that resulted in the creation of blocked times is received at an invitee device, the blocked times may be identified as available times in an availability response for the higher priority event and the availability response corresponding to the previously-received scheduling parameters may be updated (e.g., available times may be removed from the earlier availability response). It will be understood that an event invitation may include information that links the invitation to a previous availability operation.

Upon receipt of the availability responses from all of the invitees (or after a specified time for receiving such responses has passed), the scheduling application on initiator device 405 may identify an overlap in the time slots identified in the various availability responses. In the illustrated embodiment, the availability times 430, 435, and 440 identified in the received availability responses may be compared to identify overlapping times 470. Of the identified overlapping times 470, the initiator may select one or more times to be sent to the invitees as an event invitation. Therefore, a participant availability operation may allow an event initiator to retrieve information pertaining to the availability of proposed event invitees prior to sending an event invitation and with little or no interaction on the part of the event invitees. It will be understood that to allow a device to generate automatic availability responses, a user may be required to enable such functionality from within the scheduling application.

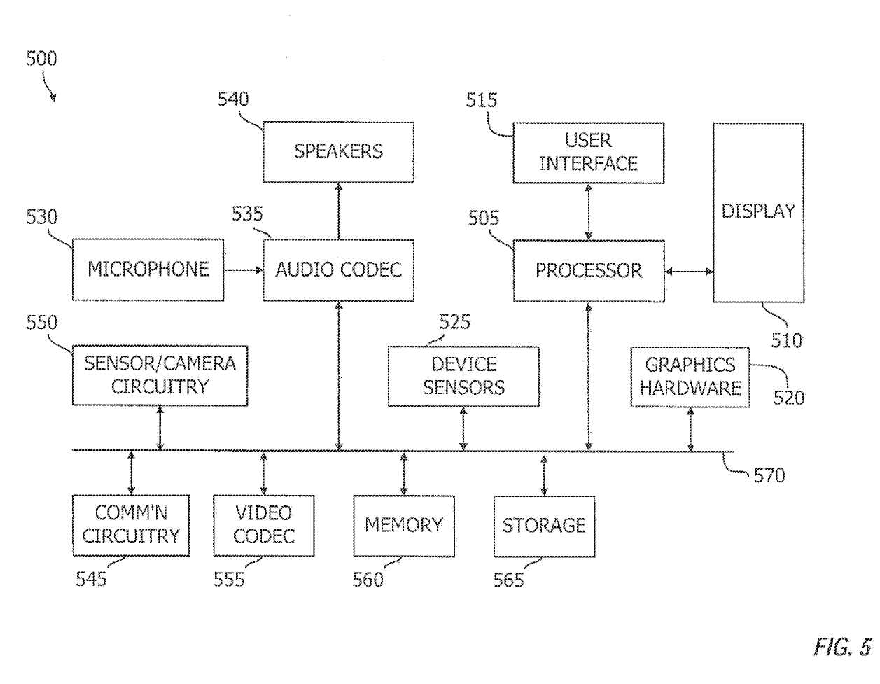

Referring to FIG. 5, a simplified functional block diagram of illustrative electronic device 500 is shown according to one embodiment. Electronic device 500 may include processor 505, display 510, user interface 515, graphics hardware 520, device sensors 525 (e.g., proximity sensor/ambient light sensor, accelerometer and/or gyroscope), microphone 530, audio codec(s) 535, speaker(s) 540, communications circuitry 545, digital image capture unit 550, video codec(s) 555, memory 560, storage 565, and communications bus 570. Electronic device 500 may be, for example, a personal digital assistant (PDA), personal music player, mobile telephone, notebook, laptop or tablet computer, desktop computer, or server computer. More particularly, a device that takes the form of device 500 may execute a scheduling application that performs the above-described operations.

Processor 505 may execute instructions necessary to carry out or control the operation of many functions performed by device 500. Processor 505 may, for instance, drive display 510 and receive user input from user interface 515. User interface 515 can take a variety of forms, such as a button, keypad, dial, a click wheel, keyboard, display screen and/or a touch screen. Processor 505 may also, for example, be a system-on-chip such as those found in mobile devices and include a dedicated graphics processing unit (GPU). Processor 505 may be based on reduced instruction-set computer (RISC) or complex instruction-set computer (CISC) architectures or any other suitable architecture and may include one or more processing cores. Graphics hardware 520 may be special purpose computational hardware for processing graphics and/or assisting processor 505 to process graphics information. In one embodiment, graphics hardware 520 may include a programmable graphics processing unit (GPU).

Sensor and camera circuitry 550 may capture still and video images that may be processed, at least in part, by video codec(s) 555 and/or processor 505 and/or graphics hardware 520, and/or a dedicated image processing unit incorporated within circuitry 550. Images so captured may be stored in memory 560 and/or storage 565. Memory 560 may include one or more different types of media used by processor 505 and graphics hardware 520 to perform device functions. For example, memory 560 may include memory cache, read-only memory (ROM), and/or random access memory (RAM). Storage 565 may store media (e.g., audio, image and video files), computer program instructions or software, preference information, device profile information, and any other suitable data. Storage 565 may include one or more non-transitory storage mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Memory 560 and storage 565 may be used to tangibly retain computer program instructions or code organized into one or more modules and written in any desired computer programming language. When executed by, for example, processor 505, such computer program code may implement one or more of the methods described herein (e.g., operations 100 and/or 300).

It is to be understood that the above description is intended to be illustrative, and not restrictive. The material has been presented to enable any person skilled in the art to make and use the inventive concepts described herein, and is provided in the context of particular embodiments, variations of which will be readily apparent to those skilled in the art (e.g., some of the disclosed embodiments may be used in combination with each other). Many other embodiments will be apparent to those of skill in the art upon reviewing the above description. The scope of the invention therefore should be determined with reference to the appended claims, along with the full scope of equivalents to which such claims are entitled. In the appended claims, the terms “including” and “in which” are used as the plain-English equivalents of the respective terms “comprising” and “wherein.”

1. A non-transitory program storage device, readable by a processor and comprising instructions stored thereon to cause the processor to:
send an invitation for a proposed event from a first user device to a second user device, wherein the invitation specifies multiple proposed event time periods;
receive, from the second user device, an acceptance of the invitation, the acceptance specifying an accepted event time period that corresponds to one of the multiple proposed event time periods; and
set, on the first user device, a notification for the proposed event based, at least in part, on the accepted event time period.

2. The non-transitory program storage device of claim 1, further comprising instructions to cause the processor to identify the multiple proposed event time periods as blocked on the first user device.

3. The non-transitory program storage device of claim 2, further comprising instructions to cause the processor to prevent a subsequent event from being scheduled during a time period identified as blocked.

4. The non-transitory program storage device of claim 2, further comprising instructions to cause the processor to:
receive a response from the second user device that identifies one or ore conflicting time periods; and
remove the blocked identification for those time periods corresponding to the one or more conflicting time periods.

5. A device, comprising:
a memory; and
a processor operatively coupled to the memory and configured to execute program code stored in the memory to:
send an invitation for a proposed event having a plurality of proposed event time periods to a second device;
receive, from the second device, an acceptance of the invitation, the acceptance specifying an accepted event time period that corresponds to one of the proposed event time periods; and
store data corresponding to the proposed event and the accepted event time period in the memory.

6. The device of claim 5, further comprising program code to cause the processor to receive scheduling parameters for the proposed event, wherein the scheduling parameters define a proposed event duration and a proposed event time frame.

7. The device of claim 6, further comprising program code to cause the processor to identify a plurality of available time periods corresponding to the scheduling parameters.

8. The device of claim 7, further comprising program code to cause the processor to receive a selection of the plurality of proposed event time periods from the plurality of available time periods.

9. A method, comprising:
receiving, at a first user device, a selection of multiple proposed event time periods for a proposed event;
sending an invitation for the proposed event from the first user device to a second user device, wherein the invitation specifies the multiple proposed event time periods;
receiving, from the second user device, an acceptance of the invitation, the acceptance specifying an accepted event time period that corresponds to one of the multiple proposed event time periods; and
setting, on the first user device, a notification for the proposed event corresponding to the accepted event time period.

10. A non-transitory program storage device, readable by a processor and comprising instructions stored thereon to cause the processor to:
receive, by a scheduling application on a first device, scheduling parameters for a proposed event;
identify a plurality of available time periods based on the scheduling parameters;
receive, by the scheduling application, a selection of more than one proposed event time periods from the plurality of available time periods;
send an invitation for the proposed event to a second device, wherein the invitation comprises the more than one proposed event time periods; and
receive, from the second device, a response specifying one or more accepted event time periods from the more than one proposed event time periods.

11. The non-transitory program storage device of claim 10, wherein the scheduling parameters define a proposed duration and a proposed time period for the proposed event.

12. The non-transitory program storage device of claim 11, wherein the instructions to cause the processor to identify a plurality of available time periods based on the scheduling parameters comprise instructions to cause the processor to identify existing events listed in the scheduling application during the proposed time period.

13. The non-transitory program storage device of claim 10, wherein the instructions to cause the processor to identify a plurality of available time periods based on the scheduling parameters comprise instructions to cause the processor to request information regarding existing events from a plurality of applications on the first device.

14. The non-transitory program storage device of claim 10, further comprising instructions to cause the processor to determine whether the received response finalizes scheduling of the proposed event.

15. The non-transitory program storage device of claim 14, wherein the instructions to cause the processor to determine whether the received response finalizes scheduling of the proposed event comprise instructions to cause the processor to:
determine that the response is from a sole invitee; and
determine the response specifies a single accepted event time period corresponding to one of the proposed event time periods.

16. The non-transitory program storage device of claim 14, further comprising instructions to cause the processor to set a notification on the first device when the received response finalizes scheduling of the proposed event.

17. The non-transitory program storage device of claim 10, further comprising instructions to cause the processor to:
receive a selection of one of the specified one or more accepted event time periods; and
send the selected accepted event time period to the second device.

18. A non-transitory program storage device, readable by a processor and comprising instructions stored thereon to cause the processor to:
receive, at a second device and from a first device, an event invitation that identifies multiple proposed event times;
identify one or more of the proposed event times as conflicting with one or more existing events;
present the proposed event times that are not identified as conflicting with the one or more existing events;
receive a selection of one of the presented proposed event times; and
send the selected proposed event time to the first device.

19. The non-transitory program storage device of claim 18, further comprising instructions to cause the processor to send, to the first device, the one or more proposed event times that are identified as conflicting.

20. A non-transitory program storage device, readable by a processor and comprising instructions stored thereon to cause the processor to:
receive scheduling parameters that identify a duration, a time frame, and a plurality of proposed invitees for a proposed event;
send the scheduling parameters to a plurality of invitee devices, each invitee device corresponding to one of the proposed invitees;
receive a plurality of responses from the plurality of proposed invitee devices, wherein each response specifies one or more available time periods during the proposed event time frame;
identify one or more overlapping time periods based on the proposed event time frame and the one or more available time periods specified in the plurality of responses; and
send an invitation for the proposed event to at least two of the plurality of invitee devices, wherein the invitation specifies the one or more overlapping time periods.

21. The non-transitory program storage device of claim 20, wherein the instructions to cause the processor to send the scheduling parameters to the plurality of invitee devices comprise instructions to cause the processor to send the scheduling parameters to the plurality of invitee devices substantially contemporaneously.

22. The non-transitory program storage device of claim 20, wherein the scheduling parameters comprise a ranking of more than one of the plurality of proposed invitees.

23. The non-transitory program storage device of claim 22, wherein the instructions to cause the processor to send the scheduling parameters to the plurality of invitee devices comprise instructions to cause the processor to send the scheduling parameters to the plurality of invitee devices based, at least in part, on the ranking.

24. The non-transitory program storage device of claim 20, wherein the instructions to cause the processor to identify one or more overlapping time periods comprise instructions to cause the processor to:
receive a selection of one or more necessary invitees from the plurality of proposed invitees; and
identify time periods from the plurality of responses during which the necessary invitees are available.
